(19) United States
(12) Patent Application Publication
(10) Pub. No.: US 2012/0178987 A1
(43) Pub. Date: Jul. 12, 2012

(54) Clean room discovery of environmental factors affecting children

(76) Inventor: George Scheber, Palos Park, IL (US)

(21) Appl. No.: 12/930,394

(22) Filed: Jan. 6, 2011

(51) Int. Cl. A61G 10/02

(52) U.S. Cl. 600/21

(57) ABSTRACT

By creating a place (an E Room) that can differentiate between a congenital and an environmentally based illness in an affected child, great strides will be made in controlling and eliminating environmentally based illnesses.

A child shown to be affected by environmental factors can be detoxified in an E Room and subsequently tested for reactions to a variety of substances which include food, air borne, and surface based products. Discovered environmental irritants can be reviewed for there larger population implications.

Resolving environmentally based medical problems in affected children will certainly enhance efforts to improve the environment for mankind and the earth in general.

It might be noted, that due to the current electronic industry downturn, many clean room facilities are available for conversion to E Rooms at bargain prices.

### BACKGROUND OF THE INVENTION

Clean rooms are typically used in manufacturing or scientific research that has a low level of environmental pollutants such as dust airborne microbes, aerosol particles and chemical vapors. More accurately, a clean room has a controlled level of contamination . . .

Clean Rooms are used extensively in Electronics and for Scientific Research to limit contaminants from disturbing everything from Silicon Wafers to Living Organic Cells.

Although research extends into the medical field, to detect or protect organisms, such research focuses on things other than the human body—particularly the human body in distress from unknown factors.

This gap in research shall be rectified with the introduction of an E Room.

### BRIEF SUMMARY OF THE INVENTION

Patients, particularly children, with health problems that can not be successfully treated, or even diagnosed, through normal medical methods are placed in a clean room. Unlike the “child in a bubble”, in the clean room the patient is isolated to detoxify his body from air and surface borne contaminates. Once detoxified, a marked decrease in the perceived health problem would seem to indicate that the child's symptoms were the result of environment factors.

### DETAILED DESCRIPTION OF THE INVENTION

Stage 1

Patients arrive with symptoms germane to their illness.

The patient (generally a child) and a guardian enter a Clean Room and are given an orientation on procedures—where things are, and what's available.

Two way communications are enabled, tested, and used until thoroughly understood.

As the patient may be in the Clean Room for as long as several days, many of the “conveniences and comforts of home” will be available.

Noting the difference between more traditional clean rooms and this specialized clean room, we shall hereafter refer this new experimental room as an E Room.

An E Room patient enters an environment free from harmful substances. Over time, while in this environment, it's expected that the patient's health will either markedly improve or remain unchanged. An unchanged conditioned would seem to indicate a congenital, possibly systemic, or unknown health problem, while an improved condition would seem to indicate that something in the child's “normal” environment is causing his illness.

Distinguishing between a congenital or unknown health problem and an environmentally based problem shall be deemed a success.

Stage 2

Patients believed to be environmentally challenged remain in, or return to, an E Room.

Meals are consumed and patient reactions are noted.

Meals consist of organic products.

Meals may be comprised of fruits.

Meals may be comprised of vegetables.

Meals may be comprised of animal and animal products.

Meals may be comprised of fish and fish products.

Meals may be comprised of dairy and dairy products.

Meals may be comprised of any combination of [0012-0017].

When an irritant is found to be a food or food product, its elimination from the patients' diet occurs and implications of its elimination evaluated.

A primary objective of Stage 2 testing is to establish a base line diet for patients scheduled for further testing.

Prior to Stage 3 testing, patients' will be feed non organic meals prepared and sequenced identically to earlier organic meals.

Reactions to organic verses non organic meals will be noted and appraised.

Stage 3

A series of environmental substances believed to exist “at home” are systematically introduced, exposing the patient to their affect.

Substances and substance groups include food, air borne, and surface based products.

Discovering a substance that adversely affects a patient is an immediate goal.

A substance deemed to be an irritant becomes suspect not only for the patient, but for larger populations.

After a substance is deemed harmful it will be not be reintroduced at any time during Stage 2.

Those “thought to be related” harmful substances will not be introduced at any time during Stage 2.

Realizing that discovered irritants, initially thought to be isolated incidents, may actually be more widespread, all data deemed relevant shall be cataloged.

Reoccurrences of similar or related irritants amongst patients will be investigated as evidence of the irritants pervasiveness mounts.

When a discovered irritant appear to be pervasive in the patients' home environment, its eradication should be accomplished before the patient returns home.

After the discovery of an irritant, or irritants, Stage 3 testing may or may not be halted as circumstance may or may not suggest.

Stage 4

In the case where the exposure to individual substance fails to uncover an irritant patients may be exposed to a combinations of substances.

Combinations of substances may be suggested from ongoing data collection and continuing research.

Special attention will be given to substance combinations that are shown to be irritants.

Initially each element of a substance combination will be considered a possible trigger or catalyst.

Initially each element of a substance combination will be considered an irritant.

Required “life elements” such as clean air and pure water shall not be considered irritants for obvious reasons.

1. A room that has a controlled level of contamination and is designed for patients who may be suffering from environmental irritants shall be referred to as an E Room.

2. A patient can be isolated from everyday irritants once placed in an E Room as described in claim 1 above.

3. Over time, isolation as described in claim 1 above, from irritants can detoxify a patient from food, air, and surface borne contaminates.

4. An E Room will aid in determining if a patients' illness can be attributable to environmental factors.

5. An E Room will aid in determining if a patients' illness can be attributable to factors other than environmental.
